(19) United States
(12) Patent Application Publication
(10) Pub. No.: US 2026/0244236 A1
(43) Pub. Date: Aug. 20, 2026

(54) MOSFET Current Mirror With Fast Startup Time

(71) Applicant: InvenSense, Inc., San Jose, CA (US)

(72) Inventor: Alexandre Huffenus, Grenoble (FR)

(21) Appl. No.: 19/053,922

(22) Filed: Feb. 14, 2025

(51) Int. Cl. G05F 3/26

(52) U.S. Cl. CPC G05F 3/262

(57) ABSTRACT

A current mirror is configured for fast startup from an “off” state, supplying a controlled current to multiple outputs of the current mirror. A startup transistor such as a MOSFET is coupled to receive an input current of the current mirror at a gate of the MOSFET and to conduct a current from a startup current source to a shared node of the current mirror based on an input voltage at the gate of the MOSFET due to the provided input current. A finite non-zero finite DC impedance is also connected to the shared node to condition the startup characteristics of the current mirror output.

### BACKGROUND

Numerous items such as smart phones, smart watches, tablets, automobiles, aerial drones, appliances, aircraft, exercise aids, and game controllers may utilize sensors such as microelectromechanical system (MEMS) sensors during their operation. In many applications, various types of motion sensors such as accelerometers and gyroscopes may be analyzed independently or together in order to determine varied information for particular applications. For example, gyroscopes and accelerometers may be used in gaming applications (e.g., smart phones or game controllers) to capture complex movements by a user, drones and other aircraft may determine orientation based on gyroscope measurements (e.g., roll, pitch, and yaw), and vehicles may utilize measurements for determining direction (e.g., for dead reckoning) and safety (e.g., to recognizing skid or roll-over conditions).

Multiple MEMS sensors may be packaged together in a single package and may have a variety of circuits (e.g., within an application specific integrated circuit (“ASIC”)) that operate at different times and under different conditions. Power may be distributed from a power source to multiple sub-circuits via a number of current mirrors, which in turn control the timing of providing power to the respective sub-circuits. As an example, a MEMS sensor package may be implemented in battery powered or other power-sensitive devices, such that it is desirable to limit power consumption. Certain sub-circuits may be cycled on and off periodically, while other sub-circuits may be turned on only upon the occurrence of certain conditions. While such sleep, idle, or other similar modes may help to limit power consumption, there is a delay (e.g., startup time) before the sub-circuits are operational that can be detrimental to overall device performance and responsiveness.

### SUMMARY

In an embodiment of the present disclosure, a current mirror comprises an input transistor comprising an input node at a first node of the input transistor that receives a reference input current, a second node of the input transistor connected to a first reference voltage, and a third node of the input transistor connected at a shared node. The current mirror may further comprise an output transistor comprising an output node at a first node of the output transistor, a second node of the output transistor connected to the first reference voltage, and a third node of the output transistor connected to the shared node. The current mirror may further comprise a startup transistor comprising a first node of the startup transistor connected to a second reference voltage, a second node of the startup transistor connected to the shared node, and a third node of the startup transistor connected to the input node, wherein based on a startup signal at the third node of the startup transistor the startup transistor provides a path for a current to flow between the second reference voltage and the shared node. The current mirror may further comprise one or more components connected between the shared node and the first reference voltage, wherein the one or more components have a non-zero DC impedance, and wherein the one or more components create a DC current path between the shared node and the first reference voltage.

In an embodiment of the present disclosure, a method of controlling startup characteristics of a current mirror comprises receiving an input current at a first node of an input transistor and blocking, by a startup transistor based on a first voltage at the first node relative to a threshold, a startup current from being provided to a common gate node of the current mirror between a shared node of the input transistor and an output transistor. The method may further comprise providing, based on a second voltage at the first node relative to a second threshold, the startup current to the shared node. The method may further comprise dissipating the startup current at the shared node when the startup current is initially provided to the shared node, wherein after the dissipating a voltage at the shared node reaches a steady state value that allows a fixed current to be provided at an output node of the output transistor.

In an embodiment of the present disclosure, a current mirror having a decreased startup time comprises an input voltage-controlled transistor having an input terminal coupled to receive at least a first portion of a reference current from a reference current source and an output voltage-controlled transistor coupled to conduct an output current of the current mirror, the input voltage-controlled transistor and the output voltage-controlled transistor having respective control terminals coupled to each other at a common control node. The current mirror may further comprise a start-up voltage-controlled transistor having a switchable conductive path coupled between a reference voltage and the common control node and operable in response to the reference current source to charge a parasitic capacitance between the common control node and a reference node when the switchable conductive path is in a conductive state. The current mirror may further comprise a non-zero finite impedance coupled between the common control node and the reference node.

### BRIEF DESCRIPTION OF DRAWINGS

The above and other features of the present disclosure, its nature, and various advantages will be more apparent upon consideration of the following detailed description, taken in conjunction with the accompanying drawings in which:

FIG. 1 shows an illustrative MEMS system in accordance with an embodiment of the present disclosure;

FIG. 2 depicts a schematic diagram of a MOSFET current mirror;

FIG. 3A depicts a schematic diagram of a MOSFET current mirror with multiple output transistors;

FIG. 3B depicts a schematic diagram of a MOSFET current mirror with multiple output transistors and their combined representative parasitic capacitor;

FIG. 4A depicts a plot of how the gate-source voltage of the input MOSFET changes during startup in certain configurations;

FIG. 4B depicts a plot of how the output current of the output MOSFET changes during startup in certain configurations;

FIG. 5A depicts a plot of how the gate-source voltage of the input MOSFET changes during startup under two different starting voltage conditions;

FIG. 5B depicts a plot of how the output current of the output MOSFET changes during startup under two different starting conditions;

FIG. 6 depicts a schematic diagram of a MOSFET current mirror including a startup transistor in accordance with an embodiment of the present disclosure;

FIG. 7A depicts a plot of how the gate-source voltage of the input MOSFET changes during startup under three different starting conditions in accordance with an embodiment of the present disclosure;

FIG. 7B depicts a plot of how the output current of the output MOSFET changes during startup under three different starting conditions in accordance with an embodiment of the present disclosure;

FIG. 8A depicts a schematic diagram of a MOSFET current mirror including a startup transistor and a DC pull-down in accordance with an embodiment of the present disclosure;

FIG. 8B depicts a schematic diagram of a MOSFET current mirror including a startup transistor and a DC pull-down transistor in accordance with an embodiment of the present disclosure;

FIG. 9A depicts a plot of how the gate-source voltage of the input MOSFET changes during startup under four different starting conditions in accordance with an embodiment of the present disclosure;

FIG. 9B depicts a plot of how the output current of the output MOSFET changes during startup under four different starting conditions in accordance with an embodiment of the present disclosure;

FIG. 10 depicts a schematic diagram of a MOSFET current mirror including a startup transistor, DC pull-down transistor, and a capacitor in parallel with the input transistor in accordance with an embodiment of the present disclosure;

FIG. 11A depicts a plot of how the output current of the output MOSFET changes during startup under five different starting conditions in accordance with an embodiment of the present disclosure;

FIG. 11B depicts a plot of how the output current of the output MOSFET changes during startup under four different starting conditions in accordance with an embodiment of the present disclosure;

FIG. 12A depicts a plot of how the gate-source voltage of the input MOSFET changes during startup and shutdown under four different starting conditions in accordance with an embodiment of the present disclosure;

FIG. 12B depicts a plot of how the current from the DC pull-down transistor changes during startup and shutdown under two different starting conditions in accordance with an embodiment of the present disclosure;

FIG. 12C depicts a plot of how total current of the current mirror changes during startup and shutdown under four different starting conditions in accordance with an embodiment of the present disclosure;

FIG. 13A depicts a schematic diagram of a MOSFET current mirror with a representative parasitic capacitor and an additional capacitor and enabling circuit;

FIG. 13B depicts a plot of how the gate-source voltage of the input MOSFET changes over time with and without the presence of an additional capacitor and enabling circuit upon initiating the flow of input current;

FIG. 14A depicts a schematic diagram of a MOSFET current mirror including a startup transistor, DC pull-down transistor, and a cascode at the output in accordance with an embodiment of the present disclosure;

FIG. 14B depicts a schematic diagram of a MOSFET current mirror including a startup transistor, DC pull-down transistor, and cascodes at the input and output in accordance with an embodiment of the present disclosure;

FIG. 14C depicts a schematic diagram of a MOSFET current mirror including a startup transistor, DC pull-down transistor, cascodes at the input and output, and a capacitor in parallel with the input transistor in accordance with an embodiment of the present disclosure;

FIG. 14D depicts a schematic diagram of a MOSFET current mirror including a startup transistor, DC pull-down transistor, and resistor degeneration at both the input and output in accordance with an embodiment of the present disclosure;

FIG. 14E depicts a schematic diagram of a MOSFET current mirror containing shutdown transistors, a startup transistor, a DC pull-down transistor in accordance with an embodiment of the present disclosure;

FIG. 14F depicts a schematic diagram of a MOSFET current mirror containing shutdown transistors, a startup transistor, a DC pull-down transistor, and cascodes at the input and output in accordance with an embodiment of the present disclosure; and

FIG. 15 depicts a flow diagram for a method of controlling the startup characteristics of a current mirror according to one aspect of an embodiment within the present disclosure.

### DETAILED DESCRIPTION

A sensor such as a MEMS sensor includes numerous sub-circuits within portions of the MEMS sensor and/or within a sensor package. The sub-circuits may be located at different locations such that it is desirable to provide power to the sub-circuit locally, for example, proximate to the sub-circuit being powered. A current mirror can control the current applied at each of the sub-circuits via an interconnection of an input transistor (e.g., an input MOSFET) and output transistors (e.g., output MOSFETS) associated with each of the sub-circuits, at a common shared node of the input transistor and the output transistors. The current supplied to the input transistor within the current mirror controls the current supplied by each of the output transistors to each of the sub-circuits, based on known design parameters of the input transistor and the output transistors. A startup transistor supplies power to the shared node to enhance (i.e., lower) the startup time for the current mirror. In this manner, a parasitic capacitance associated with a series of output transistors does not unduly delay the operation (e.g., conducting current) of the output transistors, substantially decreasing the startup time for the current mirror in a manner that does not require pre-charging or other power-draining techniques. A finite non-zero DC impedance may be connected between the shared node and a reference voltage to dissipate an initial startup current and voltage applied by the startup transistor, for example, to limit overshoots and ringing as the startup transistor applies the current to the shared node. Additional circuit elements such as cascoded designs and enabling signals may further be utilized to achieve desired startup characteristics.

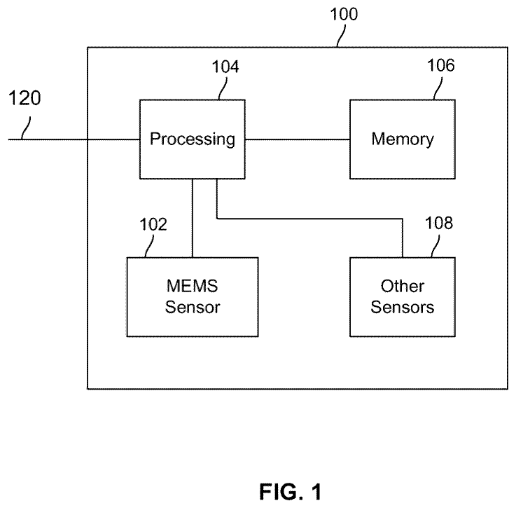

FIG. 1 shows an illustrative MEMS system 100 in accordance with an embodiment of the present disclosure. Although particular components are depicted in FIG. 1, it will be understood that other suitable combinations of the MEMS, processing components, memory, and other circuitry may be utilized as necessary for different applications and systems. In accordance with the present disclosure, the MEMS system may include a MEMS sensor 102 as well as additional sensors 108. Although the present disclosure will be described in the context of signals within packaging or a die of MEMS sensors, it will be understood that the current mirror startup configurations and methods of the present disclosure may be utilized with a variety of different electronic circuits and devices, e.g., where current is distributed to different subcircuits via a current mirror.

Processing circuitry 104 may include one or more components providing processing based on the requirements of the MEMS system 100. In some embodiments, processing circuitry 104 may include hardware control logic that may be integrated within a chip of a sensor (e.g., on a base substrate of a MEMS sensor 102 or other sensors 108, or on an adjacent portion of a chip to the MEMS sensor 102 or other sensors 108) to control the operation of the MEMS sensor 102 or other sensors 108 and perform aspects of processing for the MEMS sensor 102 or the other sensors 108. In some embodiments, the MEMS sensor 102 and other sensors 108 may include one or more registers that allow aspects of the operation of hardware control logic to be modified (e.g., by modifying a value of a register). In some embodiments, processing circuitry 104 may also include a processor such as a microprocessor that executes software instructions, e.g., that are stored in memory 106. The microprocessor may control the operation of the MEMS sensor 102 by interacting with the hardware control logic and processing signals received from MEMS sensor 102. The microprocessor may interact with other sensors 108 in a similar manner. In some embodiments, some or all of the functions of the processing circuitry 104, and in some embodiments, of memory 106, may be implemented on an application specific integrated circuit (“ASIC”) and/or a field programmable gate array (“FPGA”).

Although in some embodiments (not depicted in FIG. 1), the MEMS sensor 102 or other sensors 108 may communicate directly with external circuitry (e.g., via a serial bus or direct connection to sensor outputs and control inputs), in an embodiment the processing circuitry 104 may process data received from the MEMS sensor 102 and other sensors 108 and communicate with external components via a communication interface 110 (e.g., a serial peripheral interface (SPI) or I2C bus, in automotive applications a controller area network (CAN) or Local Interconnect Network (LIN) bus, or in other applications a suitably wired or wireless communications interface as is known in the art). The processing circuitry 104 may convert signals received from the MEMS sensor 102 and other sensors 108 into appropriate measurement units (e.g., based on settings provided by other computing units communicating over the communication interface 110) and perform more complex processing to determine measurements such as orientation or Euler angles, and in some embodiments, to determine from sensor data whether a particular activity (e.g., walking, running, braking, skidding, rolling, etc.) is taking place. In some embodiments, some or all of the conversions or calculations may take place on the hardware control logic or other on-chip processing of the MEMS sensor 102 or other sensors 108.

In some embodiments, certain types of information may be determined based on data from multiple MEMS gyroscopes 102 and other sensors 108 in a process that may be referred to as sensor fusion. By combining information from a variety of sensors it may be possible to accurately determine information that is useful in a variety of applications, such as image stabilization, navigation systems, automotive controls and safety, dead reckoning, remote control and gaming devices, activity sensors, 3-dimenstional cameras, industrial automation, and numerous other applications.

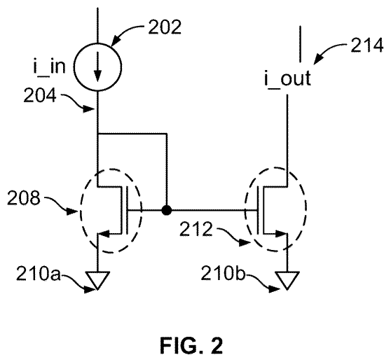

FIG. 2 depicts a schematic diagram of a MOSFET current mirror. This current mirror schematic may exist in any number of electronic devices (e.g., sensors, power controllers) or circuits (e.g., analog, digital). Current mirrors serve to identify a reference current at their input and to replicate a constant and proportional current at their output to effectuate current flow at other parts of the circuit. A variety of electrical components may be utilized to achieve this goal. In this depicted configuration, an input current 202 is supplied to the circuit via electrical connections 204 (e.g., wires) and connects to a shared node between the gate of an input transistor 208 and the gate of an output transistor 212. These transistors may be P-channel or N-channel MOSFETS (e.g., P-MOS or N-MOS). The input current 202 activates the gate of the input transistor 208 that is connected to reference voltage (e.g., ground) 210a at its source. The gate of the output transistor 212, that is connected to the reference voltage (e.g., ground) 210b at its source, is simultaneously activated by the input current 202 that generates a flow of output current 214 at other parts of the circuit.

Input current 202 may be provided to the current mirror from anywhere within the circuit. The input current 202 may vary in magnitude and be AC, DC, or a composite waveform (e.g., AC with an overlapped DC). Replicating or generating a proportional current to the input current 202 at other points throughout the circuit and/or device may be achieved using the current mirror. The input current 202 may be a signal generated from a power source or any other current-producing component. Any number and type of component within the current mirror may receive the input current 202 (either directly or indirectly), such as capacitors, transistors, resistors, inductors, or diodes. In FIG. 2, the input transistor 208 and output transistor 212 directly receive the input current 202 at their respective gate terminal, which may cause current to flow between the drain and source terminals of the transistors. The input current 202 may flow from the drain of the input transistor 208 to ground 210a located at its source terminal. The output current 214 that is generated at the drain of the output transistor 212 may flow from another section of the circuit to the ground 210b located at its source terminal, in a manner that is proportional to the input current 202 based on circuit design (e.g., matching of characteristics of the MOSFETs).

Electrical connections 204 are present throughout the current mirror. These connections are used to allow for the relatively unimpeded flow of current between any component within an electrical circuit. The dimensions and geometrical configuration of the electrical connections 204 may vary not only between current mirrors, but also within current mirrors. The electrical connections 204 may be wires, copper traces, plugs, connectors, solders, busbars, or any other electrically conductive material. Generally, the thicker and more robust the electrical connection 204, the more current that can be safely and efficiently transferred along the connection between circuit components. Both input current 202 and output current 214 may flow along the electrical connections 204.

An input transistor 208 is utilized in a current mirror to assist in receiving the input current 202 and setting a reference current for other parts of the circuit to replicate. While the transistor in this instance is represented by a MOSFET (e.g., P-channel, N-channel), the circuit may be modified to accommodate other types of transistors such as a BJT, FET, IGBT, HBT, TFT, FinFET, or UJT. A MOSFET consists of three terminals: a source, a gate, and a drain. Within this current mirror schematic, the input current 202 is received by both the drain and gate terminals of the input transistor 208. The applied voltage to the gate permits the flow of the input current 202 (as long as the threshold voltage of the transistor is reached) through the input transistor 208 out to its source terminal to ground 210a. Some implementations may consist of multiple transistors, a combination of MOSFET types, and/or a combination of transistor types. Other components (e.g., resistor, diode) may be connected to the different terminals of the input transistor 208.

Ground 210 is a common reference voltage that can be used as a return path for currents or signals. It may be useful for measuring particular voltages across components within the circuit. Noise and interference signals are also minimized by using a ground 210 connection. The specific type of ground 210 used in a current mirror will vary depending on the application of the device. For example, ground 210 may be signal ground in one current mirror, but chassis ground in another current mirror. Other examples include earth ground, power ground, and floating ground. Any component within the current mirror circuit may be connected to ground 210. In this implementation, the source of both the input transistor 208 and the output transistor 212 are connected to ground 210.

An output transistor 212 facilitates the generation of an output current 214 (e.g., a replication or proportional output compared to the input current 202) that may be utilized by other circuitry connected to the output current 214. Similar to the input transistor 208, the output transistor 212 in this implementation is represented by a MOSFET (e.g., P-channel, N-channel). The circuit may be modified to accommodate other types of transistors such as a BJT, FET, IGBT, HBT, TFT, FinFET, or UJT. Within this current mirror schematic, the input current 202 is received by the gate terminal of the output transistor 212. The applied voltage to the gate of output transistor 212 may cause an output current 214 to flow from the drain of the output transistor 212 to its source that is connected to ground 210b, with the amount of current being based on the respective current source connected to the drain of output transistor 212 and the respective characteristics of the output transistor 212 relative to input transistor 208. Some configurations may consist of multiple transistors, a combination of MOSFET types, and/or a combination of transistor types. Other components (e.g., resistor, diode) may be connected to the different terminals of the output transistor 212. The ability of the output transistor 212 to aid in replicating or generating a proportional and constant output current 214 at one of its terminals facilitates the provision of a controlled current to other circuitry connected to output current 214.

When the gate of the output transistor 212 is activated, current is able to flow from the drain to the source, thus causing one or multiple proportional currents to flow at various portions of the connected circuitry. Similar to and based on the input current 202, the output current 214 may vary in magnitude and be AC, DC, or a composite waveform (e.g., AC with an overlapped DC). Depending on the design of the current mirror, the input current 202 may be replicated at multiple output transistors 212 in order to generate multiple parallel output currents 214.

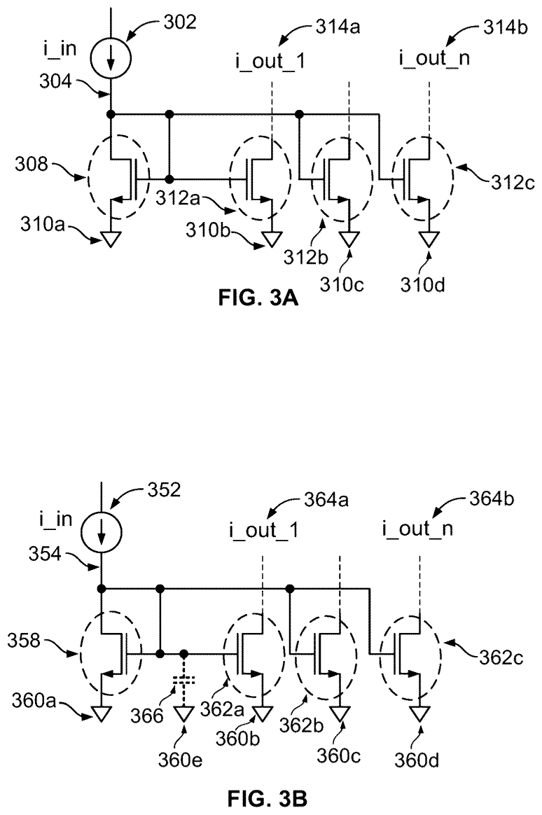

FIG. 3A depicts a schematic diagram of a MOSFET current mirror with multiple output transistors. This current mirror is similar to and functions in a similar manner as that of the current mirror in FIG. 2. However, additional output transistors 312 have been added in parallel in order to generate multiple parallel output currents 314. The input current 302 is connected to the gate terminals of each of the output transistors 312. This configuration thus allows for a single input current 302 to produce multiple identical or scaled output currents 314.

The numbered elements of FIG. 3A are similar to and function in a similar manner as the components of FIG. 2 (e.g., input current 302 corresponds to input current 202, electrical connections 304 correspond to electrical connections 204, input transistor 308 corresponds to input transistor 208, reference voltages 310 correspond to reference voltages 210, output transistors 312 correspond to output transistor 212, and output currents 314 correspond to output current 214). Each output transistor 312 is connected to the reference voltage 310 (e.g., ground) and the single input current 302 is connected to the gate terminals of each respective individual output transistor 312. Such a configuration allows for a single input current 302 to produce multiple identical or scaled output currents 314.

FIG. 3B depicts a schematic diagram of a MOSFET current mirror with multiple output transistors and their combined representative parasitic capacitor. This current mirror is similar to and functions in a similar manner as that of the current mirror in FIG. 3A (e.g., input current 352 corresponds to input current 302, electrical connections 354 correspond to electrical connections 304, input transistor 358 corresponds to input transistor 308, reference voltages 360 correspond to reference voltages 310, output transistors 362 correspond to output transistors 312, and output currents 364 correspond to output currents 314). However, a parasitic capacitor 366 has been drawn in parallel to the output transistors 312 to represent the combined parasitic capacitance of the input and output transistor (e.g., or output transistors when there are multiple transistors). For example, the gate-to-source and gate-to-drain capacitances of all the output transistors 312 may accumulate to levels such that they have significant impacts on the functionality and performance of the current mirror, for example, by requiring “charging” of the parasitic capacitance 366 during a startup cycle from a sensor sleep or idle mode, and thus increasing the startup time required to active the current mirrors and associated circuitry.

The numbered elements of FIG. 3B are similar to and function in a similar manner as the components of FIG. 3A. However, a parasitic capacitor 366 has been drawn in parallel to the output transistors 312 to represent the combined parasitic capacitances at the shared nodes of the gates of the input transistor 358 and output transistors 362. One example is the gate-to-source capacitance, which forms due to the overlap between the gate terminal and source regions within the MOSFET. Similarly, gate-to-drain capacitance values exist due to the overlap between the MOSFET gate and drain internal structures. There are many other capacitance values that may accumulate (e.g., wiring/connection capacitance) and slow down the response time and charging time of the current mirror.

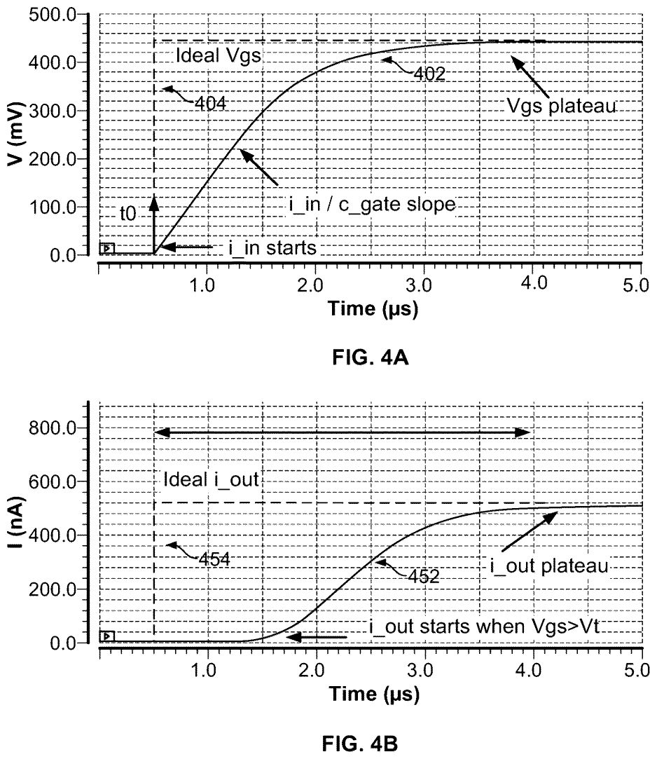

FIG. 4A depicts a plot of how the gate-source voltage of the input MOSFET changes during startup in certain configurations. The plot of FIGS. 4A and 4B correspond to an implementation such as that depicted in FIG. 3B, where a large parasitic capacitance is located between the shared node of the gate inputs to the transistors of the current mirror, for example, due to multiple current mirror output transistors supplying current to different sub-circuits throughout a circuit or device. For FIG. 4A, the abscissa represents time and is in units of microseconds. The ordinate is the gate-source voltage (V_{gs}) of the input transistor and is in units of millivolts. Both the real changes in V_{gs} over time after initiating input current flow 402 and the ideal changes in V_{gs} over time after initiating current flow 404 are plotted on the chart.

The ideal changes in V_{gs} over time 404 are plotted using a dashed line. Before input current is flowing, V_{gs} of the input transistor is 0 mV. As soon as the input current is flowing (t₀), V_{gs} increases instantaneously to a predetermined value (~440 mV). This predetermined value may be modified in other current mirrors. Once the maximum voltage is reached, V_{gs} remains constant until the input current flow is halted (not shown).

Real-time performance of V_{gs} in the current mirror over time 402 are plotted using a solid line. Before input current is flowing, V_{gs} of the input transistor is 0 mV. Upon initiating flow of the input current (t₀), V_{gs} steadily rises at a slope based on the input current and the value of the parasitic capacitor at the shared node. Larger input currents yield faster charging times of the gate capacitor and thus steeper slopes. Larger gate parasitic capacitors yield slower charging times and thus more gradual slopes. After an elapsed period of time, V_{gs} begins to slowly stabilize until the predetermined voltage value is reached. In FIG. 4A, the curve requires about 3.6 μs (after initiating input current flow) before stabilizing at a ~440 mV plateau. Once the maximum voltage is reached, V_{gs} remains constant until the input current flow is halted (not shown).

FIG. 4B depicts a plot of how the output current of the output transistor (e.g., MOSFET) changes during startup in certain configurations. The abscissa is time and is in units of microseconds. The ordinate is the output current of the output transistor and is in units of nanoamps. Both the real changes in output current over time after initiating input current flow 452 and the ideal changes in output current over time after initiating current flow 454 are plotted on the chart, and correspond to an output based on the Vgs values depicted in FIG. 4A.

The ideal changes in output current over time 454 are plotted using a dashed line and represent the output transistor conducting its full current when the input signal is provided to the shared node. Before input current is flowing, output current of the output transistor is 0 nA. As soon as the input current is flowing (t₀), the threshold voltage (i.e., minimum gate-to-source voltage required to create a conductive channel between the source and drain terminals) of the MOSFET is immediately reached and the output current instantaneously rises to a predetermined maximum value (e.g., ~500 nA). This predetermined value may be modified in other current mirrors. Once the maximum output current is reached, it remains constant until the input current flow is halted (not shown).

Real-time performance of the output current from the current mirror over time 452 are plotted using a solid line. Before input current is flowing, output current of the output transistor is 0 nA. Upon initiating flow of the input current (t₀), the output current remains zero until the threshold voltage of the MOSFET is reached as depicted in FIG. 4A. Once this voltage is satisfied, then the output current may start to flow between the source and drain terminals of the MOSFET, thus allowing the output current to be conducted. The faster the threshold voltage is reached, the faster the output current may start to flow. Both internal factors (e.g., type of MOSFET and parasitic capacitance at the shared node) and external factors (e.g. temperature of electronic circuit) have an impact on the slope of the output current versus time curve. After an elapsed period of time, the output current begins to slowly stabilize until the predetermined maximum output current value is reached. In FIG. 4B, the curve requires about 1 μs to begin conducting and about 3.6 μs (after initiating input current flow) before stabilizing at a ~500 nA plateau. Once the desired output current is reached, it remains constant until the input current flow is halted (not shown).

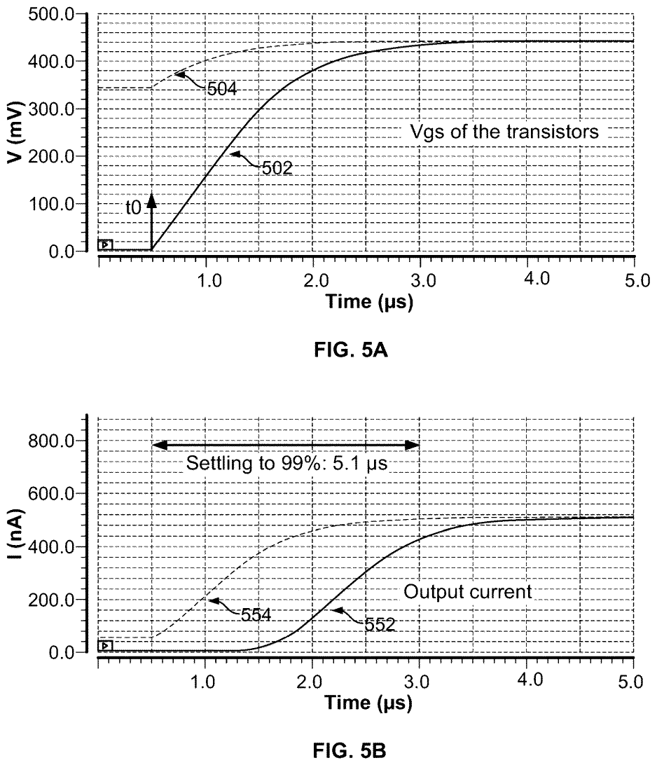

FIG. 5A depicts a plot of how the gate-source voltage of the input MOSFET changes during startup under two different starting voltage conditions. The conditions depicted and described with respect to FIGS. 5A and 5B depict a compensation technique including holding an initial startup voltage at V_{gs} and current at the output MOSFET to compensate for delayed startup time (e.g., due to parasitic capacitance). The abscissa of FIG. 5A is time and is in units of microseconds. The ordinate is V_{gs} of the input transistor and is in units of millivolts. Both the changes in V_{gs} over time after initiating input current flow 502 and the changes in V_{gs} over time after initiating current flow when a bias is already being applied to the gate of the input transistor 504 are plotted on the chart.

Performance of V_{gs} in the current mirror over time 502 are plotted using a solid line and generally corresponds to the solid line of FIG. 4A. Before input current is flowing, V_{gs} of the input transistor is 0 mV. Upon initiating flow of the input current (t₀), V_{gs} steadily rises at a slope based on the input current and the parasitic capacitance at the shared node. Larger input currents yield faster charging times of the gate capacitor and thus steeper slopes. Larger parasitic capacitances at the shared node yield slower charging times and thus more gradual slopes. After an elapsed period of time, V_{gs} begins to slowly stabilize until the predetermined voltage value is reached. In FIG. 5A, the curve requires about 3.6 μs (after initiating input current flow) before stabilizing at a ~420 mV plateau. Once the maximum voltage is reached, V_{gs} remains constant until the input current flow is halted (not shown).

Performance of V_{gs} over time after initiating current flow when a bias is already being applied to the shared node are plotted using a dashed line 504. Before input current is flowing, V_{gs} of the input transistor is already at ~345 mV due to an electrical bias being applied to the gate terminals of the input and output transistors at the shared node. Upon initiating flow of the input current (t₀), V_{gs} steadily rises, but reaches the predetermined voltage value in a lesser amount of time (relative to the unbiased gate) due to the bias already being applied to the gate terminal of the MOSFET. Thus, the plot 502 requires only about 2.5 μs (after initiating input current flow) before stabilizing at a ~420 mV plateau (faster than the unbiased gate, which required 3.6 μs). Once the maximum voltage is reached, V_{gs} remains constant until the input current flow is halted (not shown).

FIG. 5B depicts a plot of how the output current of the output MOSFET changes during startup under two different starting conditions. The abscissa is time and is in units of microseconds. The ordinate is the output current of the output transistor and is in units of nanoamps. Both the changes in output current over time after initiating input current flow 552 (corresponding to plot 502) and the changes in output current over time after initiating current flow when a bias is already being applied to the gate of the input transistor 554 (corresponding to plot 504) are plotted on the chart of FIG. 5B.

Performance of the output current from the current mirror over time 552 (i.e., corresponding to plot 502, without an applied biasing to the shared node) is plotted using a solid line. Before input current is flowing, output current of the output transistor is 0 nA. Upon initiating flow of the input current (t₀), the output current remains zero until the threshold voltage of the MOSFET is reached. Once this voltage is satisfied, then the output current may start to flow between the source and drain terminals of the MOSFET, thus eliciting an output current. The faster the threshold voltage is reached, the faster the output current may start to flow. Both internal factors (e.g., type of MOSFET) and external factors (e.g. temperature of electronic circuit) have an impact on the slope of the output current versus time curve. After an elapsed period of time, the output current begins to slowly stabilize until the predetermined maximum output current value is reached. In FIG. 5B, the curve requires about 3.6 μs (after initiating input current flow) before stabilizing at a ~500 nA plateau. Once the maximum output current is reached, it remains constant until the input current flow is halted (not shown).

Performance of the output current over time after initiating current flow when a bias is already being applied to the gate of the input transistor 554 is plotted using a dotted line. Before input current is flowing, output current of the output transistor is already at ~50 nA due to an electrical bias being applied to the shared node that causes some initial current flow through the output transistor. Upon initiating further flow of the input current (t₀), the output current steadily rises as the threshold voltage of the output transistor (e. g,, MOSFET) is satisfied. The predetermined output current value is therefore reached in a shorter amount of time (relative to the unbiased gate) due to the bias already being applied to the gate terminal of the output MOSFET. The curve requires only about 2.5 μs (after initiating input current flow) before stabilizing at a ~500 nA plateau (faster than the unbiased gate, which required 3.6 μs). Once the maximum output current is reached, it remains constant until the input current flow is halted (not shown), where it drops down to levels before the initiation of the input current flow (i.e., ~50 nA).

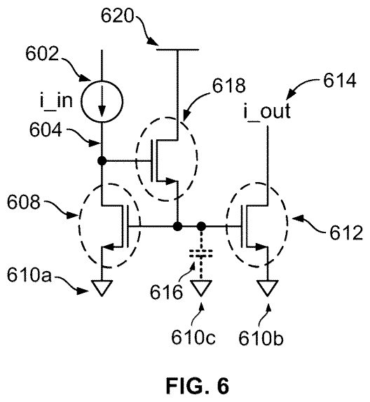

FIG. 6 depicts a schematic diagram of a MOSFET current mirror including a startup transistor in accordance with an embodiment of the present disclosure. This current mirror is similar to and functions in a similar manner as that of the current mirror in FIG. 3B (e.g., input current 602 corresponds to input current 652, electrical connections 604 correspond to electrical connections 354, input transistor 608 corresponds to input transistor 358, reference voltages 610 correspond to reference voltages 360, output transistor 612 corresponds to output transistor 362, and output current 614 corresponds to output current 364). However, a startup transistor 618 is added between the input current 602 and the gate of the output transistor 612. Electrical connections 604 connect the input current 602 to the gate terminal of the startup transistor 618 and a power source 620 is connected to its drain terminal. Upon initiating flow of the input current 602, the gate of the startup transistor 618 opens. Current may then flow from the power source 620, through the startup transistor 618, and out its source terminal to the gate terminal of the input transistor 608 and the gate terminal of the output transistor 612. The design of this current mirror ensures that the input current 602 only indirectly activates (through the startup transistor 618) the input transistor 608 and output transistor 612.

The numbered elements of FIG. 6 are similar to and function in a similar manner as the components of FIG. 3B. However, a startup transistor 618 is placed within the circuit that requires activation by the input current 602. Similar to the other transistors within the current mirror, the startup transistor 618 in this embodiment is represented by a MOSFET (e.g., P-channel, N-channel), although the embodiment may be modified to accommodate other types of startup transistors such as a BJT, FET, IGBT, HBT, TFT, FinFET, or UJT. The properties of the MOSFET (e.g., threshold voltage) may be controlled to fine-tune the functionality of the current mirror circuit. While an external power source 620 is used to provide current flow through the startup transistor 618 (upon proper activation of its gate terminal), any voltage or current source may be utilized (e.g., current source within other parts of the current mirror) as long as the cur source is able to provide the necessary power to reach the threshold voltage of both the input transistor 608 and output transistor 612. Note that the power source 620 may provide AC, DC, or a composite waveform (e.g., AC with an overlapped DC). With this design including a startup transistor 618, the input current 602 no longer directly activates the input transistor 608 and output transistor 612, but rather indirectly activates them with the assistance of the startup transistor 618. One benefit to this configuration is that the input current 602 is not required to activate multiple gates of transistors. In cases where the input current 602 is small, the time required to activate the transistors may be so large that it negatively impacts the performance of the current mirror. Using a startup transistor 618 ensures that power is not a limiting factor.

A, a current mirror having a decreased startup time comprises an input voltage-controlled transistor (e.g., input transistor 608) having an input terminal coupled to receive at least a first portion of a reference current (e.g., reference current 602) from a reference current source and an output voltage-controlled transistor (e.g., output transistor 612) coupled to conduct an output current (e.g., output current 614_ of the current mirror, the input voltage-controlled transistor and the output voltage-controlled transistor having respective control terminals coupled to each other at a common control node (e.g., the shared node coupled to the gates of input transistor 608 and output transistor 612). The current mirror may further comprise a start-up voltage-controlled transistor (e.g., startup transistor 618) having a switchable conductive path coupled between a reference voltage (e.g., power source 620) and the common control node and operable in response to the reference current source to charge a parasitic capacitance (e.g., parasitic capacitance 616) between the common control node and a reference node (e.g., reference voltage 610) when the switchable conductive path (e.g., of startup transistor 618) is in a conductive state.

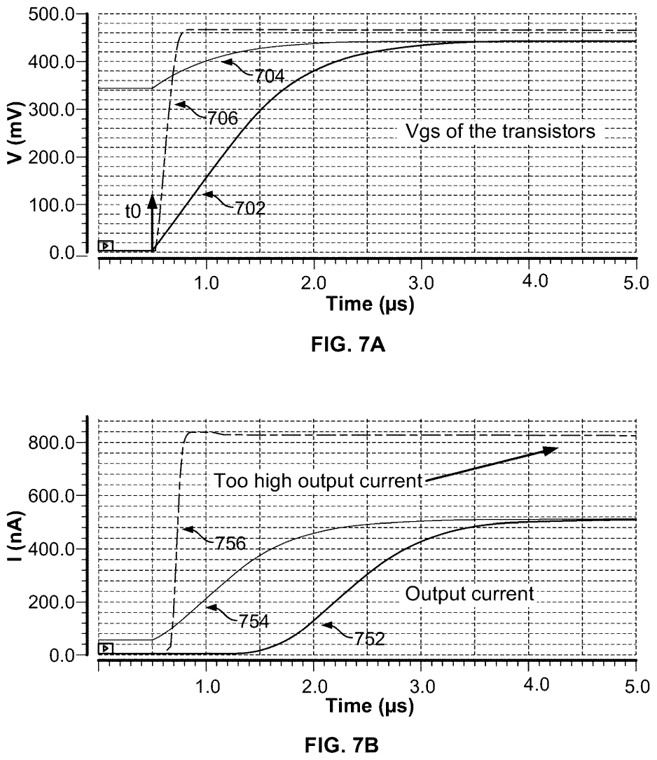

FIG. 7A depicts a plot of how the gate-source voltage of the input MOSFET changes during startup under three different starting conditions in accordance with an embodiment of the present disclosure. The plot of FIG. 7A corresponds to a circuit configuration such as depicted in FIG. 6A having a particular power source and startup MOSFET. The abscissa is time and is in units of microseconds. The ordinate is V_{gs} of the input transistor and is in units of millivolts. The changes in V_{gs} over time after initiating input current flow 702, the changes in V_{gs} over time after initiating current flow when a bias is already being applied to the gate of the input transistor 704, and the changes in V_{gs} over time after initiating current flow when a startup transistor is used in the circuit 706 are plotted on the chart.

The numbered elements of FIG. 7A are similar to the elements depicted in FIG. 5A. However, a plot that portrays the changes in V_{gs} over time after initiating current flow when a startup transistor is used in the circuit 706 is included within the chart. Before input current is flowing, V_{gs} of the input transistor is 0 mV. Upon initiating flow of the input current (t₀), V_{gs} quickly rises at a slope based on the input current from the power source and the parasitic capacitance at the shared node. The larger input current provided by the power source of the startup transistor yields a quick charging time of the gate capacitor. After a brief elapsed period of time such as 0.25 μs, V_{gs} quickly stabilizes at a level that is above the predetermined voltage value. Once the maximum voltage is reached, V_{gs} remains constant until the input current flow is halted (not shown).

FIG. 7B depicts a plot of how the output current of the output MOSFET changes during startup under three different starting conditions in accordance with an embodiment of the present disclosure, corresponding to the V_{gs} voltages of FIG. 7A. The abscissa is time and is in units of microseconds. The ordinate is the output current of the output transistor and is in units of nanoamps. The changes in output current over time after initiating input current flow 752, the changes in output current over time after initiating current flow when a bias is already being applied to the gate of the input transistor 754, and the changes in output current over time after initiating current flow when a startup transistor is used in the circuit 756 are plotted on the chart.

The numbered elements of FIG. 7B are similar to the numbered elements of FIG. 5B. However, a plot that portrays the changes in output current of the output transistor over time after initiating current flow when a startup transistor is used in the circuit 756 is included within the chart. Before input current is flowing, output current of the output transistor is 0 nA. Upon initiating flow of the input current (t₀), the output current quickly rises as the threshold voltage of the MOSFET is reached almost instantaneously due to the power source connected to the startup transistor. The faster the threshold voltage is reached, the faster the output current may start to flow. Both internal factors (e.g., type of MOSFET) and external factors (e.g. temperature of electronic circuit) have an impact on the slope of the output current versus time curve. After a brief period of time, the output current quickly stabilizes at a level that is above the predetermined current value. In FIG. 7B, the curve stabilizes at an elevated ~820 nA plateau. Once the maximum output current is reached, it remains constant until the input current flow is halted (not shown). In order to reduce the output current, configurations of the current mirror circuit need to be performed.

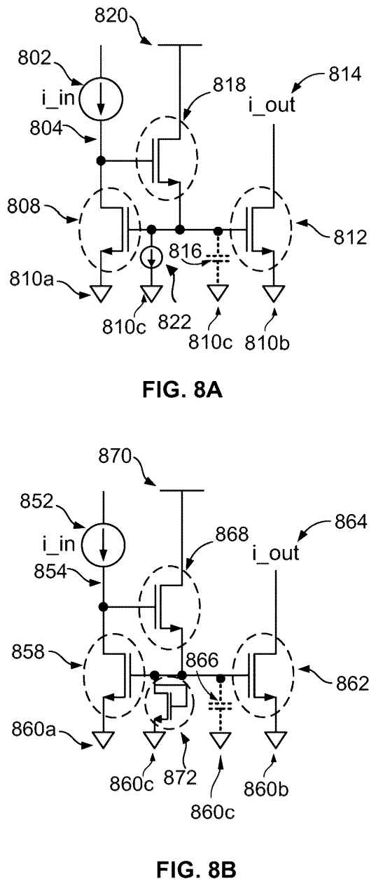

FIG. 8A depicts a schematic diagram of a MOSFET current mirror including a startup transistor and a DC pull-down in accordance with an embodiment of the present disclosure. This current mirror is similar to and functions in a similar manner as that of the current mirror in FIG. 6 (e.g., input current 802 corresponds to input current 602, electrical connections 804 correspond to electrical connections 604, input transistor 808 corresponds to input transistor 608, reference voltages 810 correspond to reference voltages 610, output transistor 812 corresponds to output transistor 612, output currents 814 correspond to output current 614, parasitic capacitance 816 corresponds to parasitic capacitance 616, startup transistor 818 corresponds to startup transistor 618, and power source 820 corresponds to power source 620). However, a DC pull-down current 822 is added between the gates of the input transistor 808 and the output transistor 812, and after the source of the startup transistor 818. Including this component may allow for a specific amount of excess current to flow to ground in order to ensure the shared gate voltage and output current 814 remains at desired levels when the power source 820 is applied via the startup transistor 818.

A DC pull-down current 822 is present within the circuit of FIG. 8. In this embodiment, the DC pull-down current 822 is located at a shared node to the source of the startup transistor 818, gate of the input transistor 808, and the gate of the output transistor 812. The other end of the DC pull-down current 822 is connected to ground 810b. The DC pull-down current 822 may be afforded by a number of different current sources. Multiple DC pull-down currents 822 may exist within a single current mirror circuit (e.g., with multiple output transistors 812 connected to the shared node). When the input current 802 is initiated, the gate of the startup transistor 818 is activated, which allows current to flow through the MOSFET to the DC pull-down current 822 and to the gate of the output transistor 812. The pathway to ground 810b through the DC pull-down current 822 may siphon current away from charging up the gate of the output transistor 812, thus reducing the current and voltage applied to the shared node in a predetermined or controlled manner (e.g., as a non-zero finite impedance). A predetermined output current 814 and predetermined V_{gs} of the output transistor 812 is more likely to be reached and maintained with this current mirror configuration. Further, as the current drawn through the DC pull-down current 822 is from the power source 820, the input current 802 may still be used as a reference current for proper functioning of the current mirror.

FIG. 8B depicts a schematic diagram of a MOSFET current mirror including a startup transistor and a DC pull-down transistor in accordance with an embodiment of the present disclosure. This current mirror is similar to and functions in a similar manner as that of the current mirror in FIG. 8A (e.g., input current 852 corresponds to input current 802, electrical connections 854 correspond to electrical connections 804, input transistor 858 corresponds to input transistor 808, reference voltages 860 correspond to reference voltages 810, output transistor 862 corresponds to output transistor 812, output currents 864 correspond to output current 814, startup transistor 868 corresponds to startup transistor 818, and power source 870 corresponds to power source 820). However, a DC pull-down transistor 872 is added at the shred node connected to the gates of the input transistor 858 and the output transistor 862 in series between the source of startup transistor 868 and reference voltage 860. Including this component allows for a specific amount of excess current to flow to ground in order to ensure the output current 864 remains at desired levels.

In this embodiment, the DC pull-down transistor 872 is located at a shared node to the source of the startup transistor 868, gate of the input transistor 858, and the gate of the output transistor 862. The other side of the DC pull-down transistor 872 is connected to ground 860b. The DC pull-down transistor 872 may be a MOSFET (e.g., P-channel, N-channel) or any other type of transistor such as a BJT, FET, IGBT, HBT, TFT, FinFET, or UJT. Multiple DC pull-down transistors 872 may exist within a single current mirror circuit. When the input current 852 is initiated, the gate of the startup transistor 868 is activated, which allows current to flow through from power source 870 the MOSFET to the DC pull-down transistor 872 and to the shared node including the gate of the output transistor 862. The pathway to ground 860b through the DC pull-down transistor 872 may siphon current away from charging up the gate of the output transistor 862, thus obviating the condition where the output current 864 exceeds the desired output current for the current mirror. A predetermined output current 864 and predetermined Vgs of the output transistor 862 is more likely to be reached and maintained with this current mirror configuration. Further, as the current drawn through the DC pull-down transistor 872 is from the power source 870, the input current 852 may still be used as a reference current for proper functioning of the current mirror. In contrast to a DC pull-down current source implemented as resistor, a DC pull-down transistor 872 may have a smaller surface area and volume.

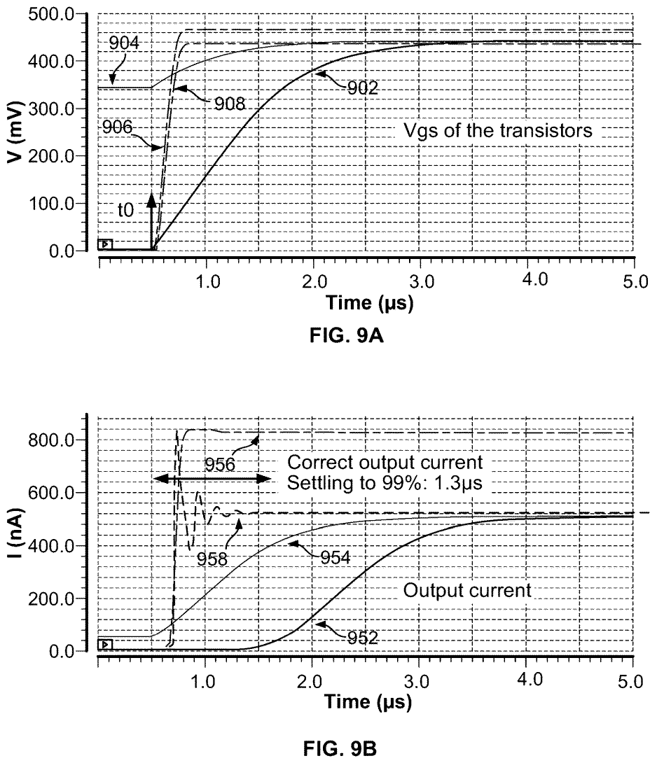

FIG. 9A depicts a plot of how the gate-source voltage of the input MOSFET changes during startup under four different starting conditions in accordance with an embodiment of the present disclosure. The abscissa is time and is in units of microseconds. The ordinate is V_{gs} of the input transistor and is in units of millivolts. The changes in V_{gs} over time after initiating input current flow 902, the changes in V_{gs} over time after initiating current flow when a bias is already being applied to the gate of the input transistor 904, the changes in V_{gs} over time after initiating current flow when a startup transistor is used in the circuit 906, and the changes in V_{gs} over time after initiating current flow when a startup transistor is used in conjunction with a DC pull-down 908 are plotted on the chart.

The numbered elements of FIG. 9A are similar to the numbered elements of FIG. 7A. However, a plot that portrays the changes in V_{gs} over time after initiating current flow when a startup transistor is used in conjunction with a DC pull-down 908 is included within the chart. Before input current is flowing, V_{gs} of the input transistor is 0 mV. Upon initiating flow of the input current (t₀), V_{gs} of plot 908 quickly rises at a slope based on the input current and the parasitic capacitance at the shared node. The larger input current provided by the power source of the startup transistor yields a quick charging time of the gate capacitor. The presence of the DC pull-down transistor ensures that V_{gs} levels do not plateau above the predetermined voltage value (as is the case for the embodiment that does not include the DC pull-down transistor). After an elapsed period of time, V_{gs} quickly stabilizes at the predetermined voltage. FIG. 9A, the curve requires about 0.65 μs (after initiating input current flow) before stabilizing at a ~420 mV plateau. Once the maximum voltage is reached, V_{gs} remains constant until the input current flow is halted (not shown).

FIG. 9B depicts a plot of how the output current of the output MOSFET changes during startup under four different starting conditions in accordance with an embodiment of the present disclosure. The abscissa is time and is in units of microseconds. The ordinate is the output current of the output transistor and is in units of nanoamps. The changes in output current over time after initiating input current flow 952, the changes in output current over time after initiating current flow when a bias is already being applied to the gate of the input transistor 954, the changes in output current over time after initiating current flow when a startup transistor is used in the circuit 956, and the changes in output current over time after initiating current flow when a startup transistor is used in conjunction with a DC pull-down 958 are plotted on the chart.

The numbered elements of FIG. 9B are similar to the numbered elements of FIG. 7B. However, a plot that portrays the changes in output current over time after initiating current flow when a startup transistor is used in conjunction with a DC pull-down 958 is included within the chart. Before input current is flowing, output current of the output transistor is 0 nA. Upon initiating flow of the input current (t₀), the output current quickly rises as the threshold voltage of the MOSFET is reached almost instantaneously due to the power source connected to the startup transistor. The faster the threshold voltage is reached, the faster the output current may start to flow. Both internal factors (e.g., type of MOSFET) and external factors (e.g. temperature of electronic circuit) have an impact on the slope of the output current versus time curve. The inclusion of the DC pull-down transistor within the current mirror is able to relatively quickly correct the overshoot by pulling some of the excess current to ground. After an elapsed period of time, the output current quickly stabilizes at the predetermined maximum output current value. In FIG. 9B, the curve requires about 0.65 μs (after initiating input current flow) before stabilizing at a ~500 nA plateau. Once the maximum output current is reached, it remains constant until the input current flow is halted (not shown).

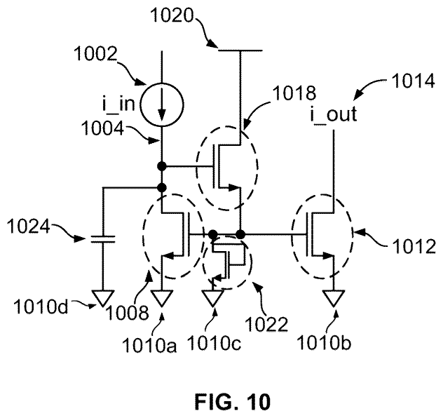

FIG. 10 depicts a schematic diagram of a MOSFET current mirror including a startup transistor, DC pull-down transistor, and a capacitor in parallel with the input transistor in accordance with an embodiment of the present disclosure. This current mirror is similar to and functions in a similar manner as that of the current mirror in FIG. 8B (e.g., input current 1002 corresponds to input current 852, electrical connections 1004 correspond to electrical connections 854, input transistor 1008 corresponds to input transistor 858, reference voltages 1010 correspond to reference voltages 860, output transistor 1012 corresponds to output transistor 862, output current 1014 corresponds to output current 864, startup transistor 1018 corresponds to startup transistor 868, and power source 1020 corresponds to power source 870). The parasitic capacitance is present at the shared node but is not depicted in FIG. 10 for ease of illustration. A capacitor 1024 is added in parallel with the input transistor 1008. The inclusion of the capacitor 1024 may allow for the output current 1014 from the output transistor 1012 to not overshoot the desired output current 1014 levels.

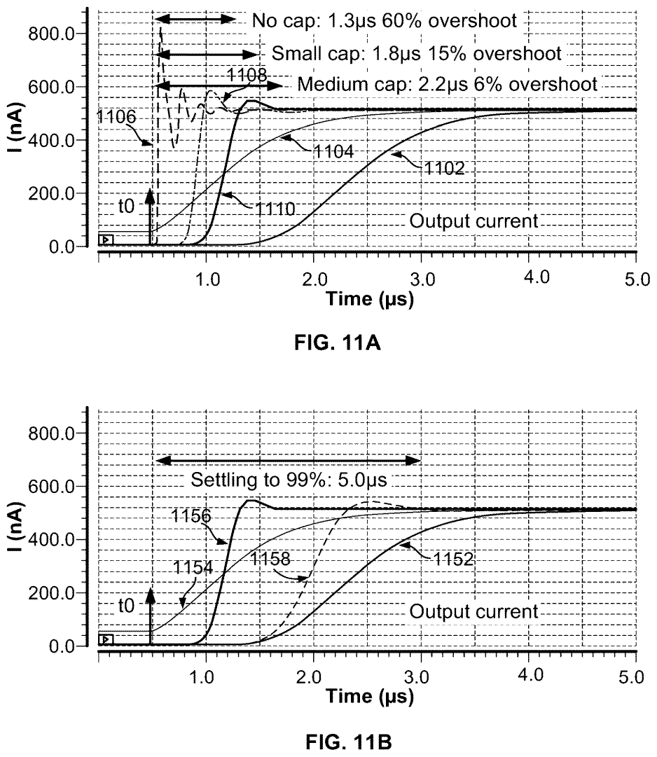

Capacitor 1024 that is connected to ground 1010 and parallel to the input transistor 1008 is present within the circuit. The size, type, and capacity of the capacitor 1024 may vary between current mirrors. By including the capacitor 1024 at this location, the input current 1002 pathway is split between the startup transistor 1018, the input transistor 1008, and the capacitor 1024. The threshold voltage of the startup transistor 1018 will require more time to be reached, which allows for a more controlled supply of current from the power source 1020 to the shared node. In turn, the more controlled gate opening enables a more steady rise in output current 1014 levels as the gate of the output transistor 1012 is also more slowly opened. At the cost of additional time (see FIG. 11A), minimal overshoot of the output current 1014 beyond the desired levels may be achieved. Reducing overshoot of output currents 1014 may be useful for sensitive components connected to current mirror output currents whose components may not be robust to withstand the elevated output currents 1014 in an overshoot situation.

FIG. 11A depicts a plot of how the output current of the output MOSFET changes during startup under five different starting conditions in accordance with an embodiment of the present disclosure. The abscissa is time and is in units of microseconds. The ordinate is the output current of the output transistor and is in units of nanoamps. The changes in output current over time after initiating input current flow 1102, the changes in output current over time after initiating current flow when a bias is already being applied to the gate of the input transistor 1104, the changes in output current over time after initiating current flow when a startup transistor is used with a DC pull-down transistor pulling 0.76 μA to ground 1106, the changes in output current over time after initiating current flow when a startup transistor is used in conjunction with a small-sized capacitor and DC pull-down transistor pulling 0.76 μA to ground 1108, and the changes in output current over time after initiating current flow when a startup transistor is used in conjunction with a medium-sized capacitor and DC pull-down transistor pulling 0.76 μA to ground 1110 are plotted on the chart.

The numbered elements of FIG. 11A are similar to the numbered elements of FIG. 9B. However, a plot that portrays the changes in output current over time after initiating current flow when a startup transistor is used in conjunction with a small-sized capacitor and DC pull-down transistor pulling 0.76 μA to ground 1108 is included within the chart. Before input current is flowing, output current of the output transistor is 0 nA. Upon initiating flow of the input current (t₀), the output current slowly rises as the threshold voltage of the MOSFET is reached. The faster the threshold voltage is reached, the faster the output current may start to flow. Due to the presence of the small-sized capacitor that is parallel with the input transistor, the threshold voltage of the gate of the output transistor is reached in more slowly manner. Both internal factors (e.g., type of MOSFET) and external factors (e.g. temperature of electronic circuit) have an impact on the slope of the output current versus time curve. Notice that while the current initially overshoots to ~575 nA (~15% higher than the desired output current), the inclusion of the DC pull-down transistor within the current mirror is able to relatively quickly correct the overshoot by pulling some of the excess current to ground. After an elapsed period of time, the output current quickly stabilizes at the predetermined maximum output current value. In FIG. 11A, the curve requires about 0.9 μs (after initiating input current flow) before stabilizing at a ~500 nA plateau. Once the maximum output current is reached, it remains constant until the input current flow is halted (not shown).

A plot that portrays the changes in output current over time after initiating current flow when a startup transistor is used in conjunction with a medium-sized capacitor and DC pull-down transistor pulling 0.76 μA to ground 1110 is also included within the chart in FIG. 11A. Before input current is flowing, output current of the output transistor is 0 nA. Upon initiating flow of the input current (t₀), the output current slowly rises as the threshold voltage of the MOSFET is reached. Due to the presence of the medium-sized capacitor that is parallel with the input transistor, the threshold voltage of the gate of the output transistor is reached even more slowly than the current mirror using the small-sized capacitor. Notice that while the current initially overshoots to ~530 nA (~6% higher than the desired output current), the inclusion of the DC pull-down transistor within the current mirror is able to correct the overshoot by pulling some of the excess current to ground. After an elapsed period of time, the output current stabilizes at the predetermined maximum output current value. In FIG. 11A, the curve requires about 1.1 μs (after initiating input current flow) before stabilizing at a ~500 nA plateau. Once the maximum output current is reached, it remains constant until the input current flow is halted (not shown). Generally, larger capacitors have reduced output current overshoots, while smaller capacitors have higher output current overshoots. Likewise, smaller overshoots require longer stabilization times of the output current. For circuits that have sensitive components, it may be necessary to use larger capacitors to reduce output current overshoots at the expense of longer stabilization times.

FIG. 11B depicts a plot of how the output current of the output MOSFET changes during startup under four different starting conditions in accordance with an embodiment of the present disclosure. The abscissa is time and is in units of microseconds. The ordinate is the output current of the output transistor and is in units of nanoamps. The changes in output current over time after initiating input current flow 1152, the changes in output current over time after initiating current flow when a bias is already being applied to the gate of the input transistor 1154, the changes in output current over time after initiating current flow when a startup transistor is used in conjunction with a medium-sized capacitor and DC pull-down transistor pulling 0.76 μA to ground 1156, and the changes in output current over time after initiating current flow when a startup transistor is used in conjunction with a medium-sized capacitor and DC pull-down transistor pulling 0.32 μA to ground 1158 are plotted on the chart.

The numbered elements of FIG. 11B are similar to and function in a similar manner as the components of FIG. 11A. However, a plot that portrays the changes in output current over time after initiating current flow when a startup transistor is used in conjunction with a larger-sized capacitor and lower DC pull-down transistor pulling 0.32 μA to ground 1158 is included within the chart. Before input current is flowing, output current of the output transistor is 0 nA. Upon initiating flow of the input current (t₀), the output current slowly rises as the threshold voltage of the MOSFET is reached. The faster the threshold voltage is reached, the faster the output current may start to flow. The reduced pulldown current from the DC pull-down transistor generally requires a larger-sized capacitor 1024 for the same overshoot on the output current, the threshold voltage of the gate of the output transistor is then reached in more slow manner. After an elapsed period of time, the output current stabilizes at the predetermined maximum output current value. In FIG. 11B, the curve requires about 2.5 μs (after initiating input current flow) before stabilizing at a ~500 nA plateau. Once the maximum output current is reached, it remains constant until the input current flow is halted (not shown). Generally, larger DC pull-down currents have reduced output current overshoots, at the expense of longer stabilization times.

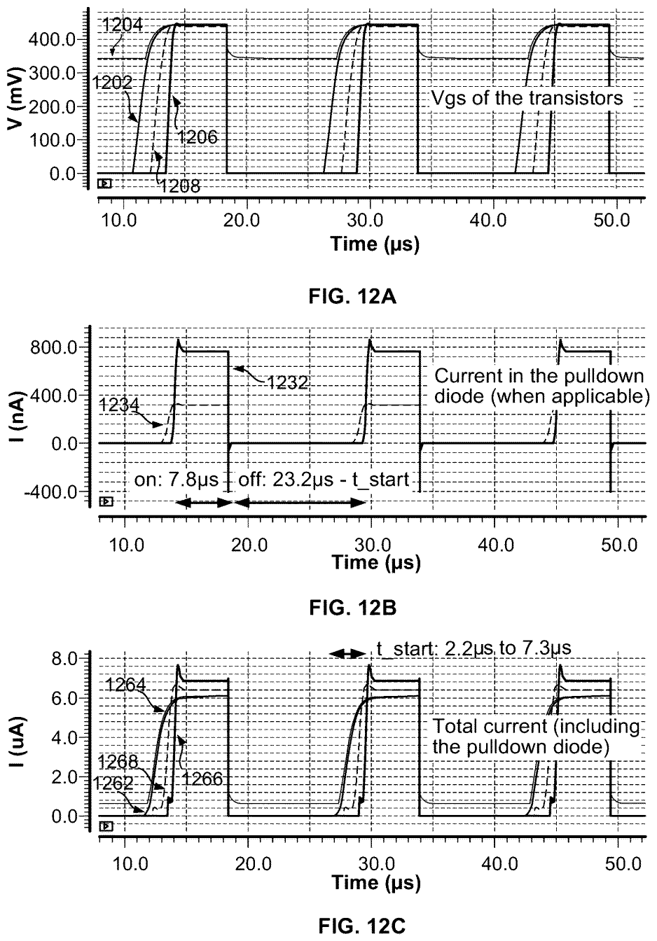

FIG. 12A depicts a plot of how the gate-source voltage of the input MOSFET changes during startup and shutdown under four different starting conditions in accordance with an embodiment of the present disclosure. The abscissa is time and is in units of microseconds. The ordinate is V_{gs} of the input transistor and is in units of millivolts. The changes in V_{gs} over time after initiating input current flow 1202, the changes in V_{gs} over time after initiating current flow when a bias is already being applied to the gate of the input transistor 1204, the changes in V_{gs} over time after initiating current flow when a startup transistor is used in conjunction with a medium-sized capacitor and DC pull-down transistor pulling 0.76 μA to ground 1206, and the changes in V_{gs} over time after initiating current flow when a startup transistor is used in conjunction with a larger-sized capacitor and DC pull-down transistor pulling 0.32 μA to ground 1208 are plotted on the chart.

A plot that portrays the changes in V_{gs} over time after initiating current flow when a startup transistor is used in conjunction with a medium-sized capacitor and DC pull-down transistor pulling 0.76 μA to ground 1206 is included within the chart of FIG. 12A. Before input current is flowing, V_{gs} of the input transistor is 0 mV. Upon initiating flow of the input current, V_{gs} quickly rises once the medium-sized capacitor, that is parallel with the input transistor, is fully charged. The presence of the DC pull-down transistor ensures that V_{gs} levels do not plateau above the predetermined voltage value (as is the case for the embodiment that does not include the DC pull-down transistor). After an elapsed period of time, V_{gs} quickly stabilizes at the predetermined voltage. Note that the inclusion of the DC pull-down does not outright prevent a significant overshoot of the predetermined voltage, but it merely just allows for the plateauing of V_{gs} at the predetermined voltage (~420 mV). Once the maximum voltage is reached, V_{gs} remains constant until the input current flow is halted. Thereafter, V_{gs} drops back down to starting levels (0 mV) and the process repeats itself with a duty cycle of ~25%. The duty cycle may vary depending on the use and configuration of the current mirror.

A plot that portrays the changes in V_{gs} over time after initiating current flow when a startup transistor is used in conjunction with a larger-sized capacitor and DC pull-down transistor pulling 0.32μA to ground 1208 is also included within the chart. Before input current is flowing, V_{gs} of the input transistor is 0 mV. Upon initiating flow of the input current, V_{gs} quickly rises once the medium-sized capacitor, that is parallel with the input transistor, is fully charged. The presence of the DC pull-down transistor ensures that V_{gs} levels do not plateau above the predetermined voltage value (as is the case for the embodiment that does not include the DC pull-down transistor). After an elapsed period of time, V_{gs} quickly stabilizes at the predetermined voltage. Note that pulling down a smaller amount of current using the DC pull-down transistor ensures that V_{gs} plateaus more rapidly. Once the maximum voltage is reached, V_{gs} remains constant until the input current flow is halted. Thereafter, V_{gs} drops back down to starting levels (0 mV) and the process repeats itself with a duty cycle of ~25%. The duty cycle may vary depending on the use and configuration of the current mirror.

FIG. 12B depicts a plot of how the current from the DC pull-down transistor changes during startup and shutdown under two different starting conditions in accordance with an embodiment of the present disclosure. The abscissa is time and is in units of microseconds. The ordinate is the current from the DC pull-down transistor and is in units of nanoamps. The changes in current from the DC pull-down transistor over time after initiating input current flow when a set pulldown current of 760 nA is chosen 1232 and the changes in current from the DC pull-down transistor over time after initiating current flow when a set pulldown current of 320 nA is chosen 1234 are plotted on the chart.

A plot that portrays the changes in current from the DC pull-down transistor over time after initiating input current flow when a set pulldown current of 760 nA is chosen 1232 is included within the chart. Before input current is flowing, current from the DC pull-down transistor is 0 nA. Upon initiating flow of the input current, the current slowly rises as the threshold voltage of the DC pull-down transistor is reached. Due to the configuration of the DC pull-down transistor, the stabilized current (~760 nA) is reached in a more slowly manner, relative to lower set DC pull-down currents. Notice that the current initially overshoots the target current, but soon afterwards stabilizes at the predetermined current value. Once the target current levels are reached, the current remains constant until the input current flow is halted. Thereafter, the current drops back down and stabilizes at starting levels (0 nA) and the process repeats itself with a duty cycle of ~25%. The duty cycle may vary depending on the use and configuration of the current mirror.

A plot that portrays the changes in current from the DC pull-down transistor over time after initiating input current flow when a set pulldown current of 320 nA is chosen 1234 is included within the chart. Before input current is flowing, current from the DC pull-down transistor is 0 nA. Upon initiating flow of the input current, the current quickly rises as the threshold voltage of the DC pull-down transistor is reached. Due to the configuration of the DC pull-down transistor, the stabilized current (~320 nA) is reached in a fairly quick manner, relative to higher set currents. Notice that the current initially overshoots the target current by a small amount, but soon afterwards stabilizes at the predetermined current value. Once the target current levels are reached, the current remains constant until the input current flow is halted. Thereafter, the current drops back down and stabilizes at starting levels (0 nA) and the process repeats itself with a duty cycle of ~25%. The duty cycle may vary depending on the use and configuration of the current mirror.

FIG. 12C depicts a plot of how total current of the current mirror changes during startup and shutdown under four different starting conditions in accordance with an embodiment of the present disclosure. The abscissa is time and is in units of microseconds. The ordinate is the total current of the current mirror and is in units of microamps. The changes in total current over time after initiating input current flow 1262, the changes in total current over time after initiating current flow when a bias is already being applied to the gate of the input transistor 1264, the changes in total current over time after initiating current flow when a startup transistor is used in conjunction with a medium-sized capacitor and DC pull-down transistor pulling 0.76 μA to ground 1266, and the changes in total current over time after initiating current flow when a startup transistor is used in conjunction with a larger-sized capacitor and DC pull-down transistor pulling 0.32 μA to ground 1268 are plotted on the chart.

A plot that portrays the changes in total current over time after initiating input current flow 1262 is included within the chart. Before input current is flowing, total current is 0 μA. Upon initiating flow of the input current, the total current quickly rises as the threshold voltages of the DC pull-down and output transistor are reached. The stabilized current (~6.1 μA) is reached fairly quickly and remains constant until the input current flow is halted. Thereafter, the total current drops back down and stabilizes at starting levels (0 nA) and the process repeats itself with a duty cycle of ~25%. The duty cycle may vary depending on the use and configuration of the current mirror.

A plot that portrays the changes in total current over time after initiating current flow when a bias is already being applied to the gate of the input transistor 1264 is included within the chart. It behaves the same as the plot that portrays the changes in total current over time after initiating input current flow 1262. However, the notable difference is that before input current is flowing, the total current is not equivalent to 0 uA, but rather ~0.60 uA. The bias that is already being applied to the gate of the input transistor causes a small amount of current leakage within the current mirror. Likewise, once the input current is halted, the total current drops down not to 0 μA, but rather ~0.60 μA.

A plot that portrays the changes in total current over time after initiating current flow when a startup transistor is used in conjunction with a medium-sized capacitor and DC pull-down transistor pulling 0.76 μA to ground 1266 is included within the chart. Before input current is flowing, total current is 0 μA. Upon initiating flow of the input current, the total current rises at the predetermined value with a smaller startup cycle time compared to current flows 1262 and 1264.. Notice that the total current initially overshoots the target current, but soon afterwards stabilizes at the predetermined current value. Once the target current levels are reached, the total current remains constant until the input current flow is halted. Thereafter, the total current drops back down and stabilizes at starting levels (0 μA) and the process repeats itself with a duty cycle of ~25%. The duty cycle may vary depending on the use and configuration of the current mirror.

A plot that portrays the changes in total current over time after initiating current flow when a startup transistor is used in conjunction with a larger-sized capacitor and DC pull-down transistor pulling 0.3 2μA to ground 1268 is included within the chart. Before input current is flowing, total current is 0 μA. Upon initiating flow of the input current, the total current rises at the predetermined value with a smaller startup cycle time compared to current flows 1262 and 1264. Due to the configuration of the DC pull-down transistor pulling 0.32 μA, the stabilized current is reached in a slightly slower manner, relative to the higher DC pull-down current of flow 1266. Notice that the current initially overshoots the target current by a small amount, but soon afterwards stabilizes at the predetermined current value. Once the target current levels are reached, the total current remains constant until the input current flow is halted. Thereafter, the total current drops back down and switching element (e.g., inverter) duty cycle may vary depending on the use and configuration of the current mirror.

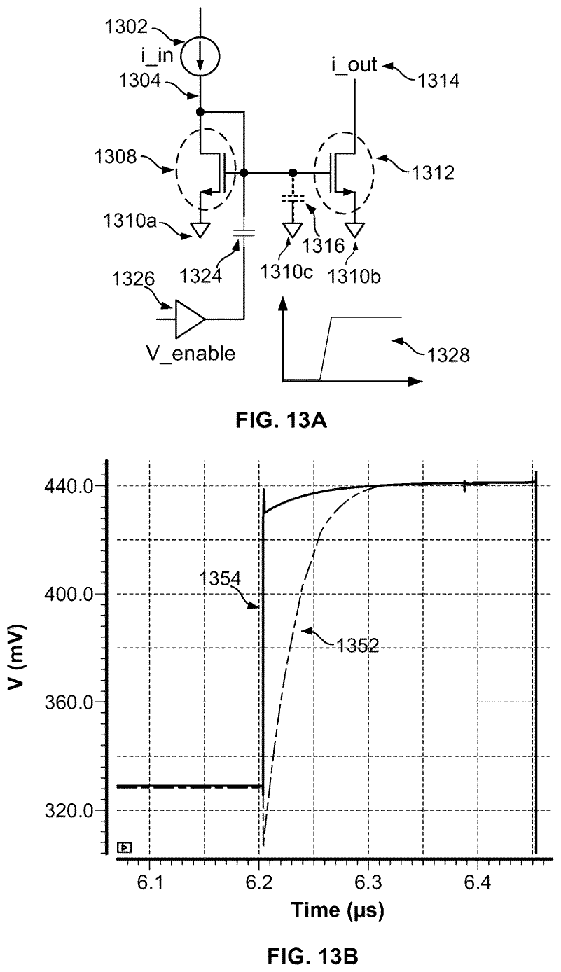

FIG. 13A depicts a schematic diagram of a MOSFET current mirror with a representative parasitic capacitor and an additional capacitor and enabling circuit. This current mirror is similar to and functions in a similar manner as that of the current mirror in FIG. 3A (e.g., input current 1302 corresponds to input current 302, electrical connections 1304 correspond to electrical connections 304, input transistor 1308 corresponds to input transistor 308, reference voltages 1310 correspond to reference voltages 310, output transistors 1312 correspond to output transistors 312, and output currents 1314 correspond to output currents 314). An additional capacitor 1324 and switching element (e.g., inverter) 1326 are connected to the shared node. The inclusion of these additional components reduces the charging time of the gate terminal of the input transistor 1308, thus allowing for its threshold voltage to be reached much more quickly when the input current 1302 is initiated.

The additional capacitor 1324 has been added to the current mirror at the shared node. The size, type, and capacity of the capacitor 1324 may vary between current mirrors. By including the capacitor 1324 at this location, the input current 1302 pathway is split between the input transistor 1308, the parasitic capacitor 1316, the output transistor 1312, and the capacitor 1324. A switching element (e.g., inverter) 1326 is added on the other side of the capacitor 1324 to control the operation of the capacitor 1324. For example, an applied voltage curve 1328 (where ordinate is voltage and abscissa is time) may be utilized that may charge the capacitor 1324 at particular points in time. As the capacitor 1324 charges, a greater amount of the input current 1302 may be dedicated to charging the gate terminal of the input transistor 1308, which reduces the charging time of the input transistor 1308. The switching element (e.g., inverter)1326 may be of any type (e.g., inverter) that achieves the desired performance of the current mirror. The applied voltage curve 1328 may have desired characteristics (e.g., pattern, frequency, amplitude, duty cycle, polarity, power source).

FIG. 13B depicts a plot of how the gate-source voltage of the input MOSFET changes over time with and without the presence of an additional capacitor and enabling circuit upon initiating the flow of input current. The ordinate is the gate-source voltage (V_{gs}) of the input transistor and is in units of millivolts. Both the changes in V_{gs} over time after initiating input current flow without the additional capacitor and switching element (e.g., inverter) 1352 and the changes in V_{gs} over time after initiating input current flow with the additional capacitor and switching element (e.g., inverter) 1354 are plotted on the chart.

A plot that portrays the changes in V_{gs} over time after initiating input current flow without the additional capacitor and switching element (e.g., inverter) 1352 is included within the chart. Before input current is flowing, V_{gs} of the input transistor is 0 mV. Upon initiating flow of the input current, V_{gs} steadily rises at a slope based on the input current and the parasitic capacitance at the shared node. After an elapsed period of time, V_{gs} begins to slowly stabilize until the predetermined voltage value is reached. In FIG. 13B, the curve requires about 0.1 μs (after initiating input current flow) before stabilizing at a ~440 mV plateau. Once the maximum voltage is reached, V_{gs} remains constant until the input current flow is halted.

A plot that portrays the changes in V_{gs} over time after initiating input current flow with the additional capacitor and switching element (e.g., inverter) 1354 is also included within the chart. Before input current is flowing, V_{gs} of the input transistor is 0 mV. Upon initiating flow of the input current, V_{gs} quickly rises at a slope based on the input current and the parasitic capacitance at the shared node. After an elapsed period of time, V_{gs} begins to quickly stabilize until the predetermined voltage value is reached. In FIG. 13B, the curve requires about 0.04 μs (after initiating input current flow) before stabilizing at a ~440 mV plateau. Compared to the plot that portrays the changes in V_{gs} over time after initiating input current flow without the additional capacitor and switching element (e.g., inverter) 1352, this plot more quickly and effectively activates the gate terminal of the input transistor. Once the maximum voltage is reached, V_{gs} remains constant until the input current flow is halted.

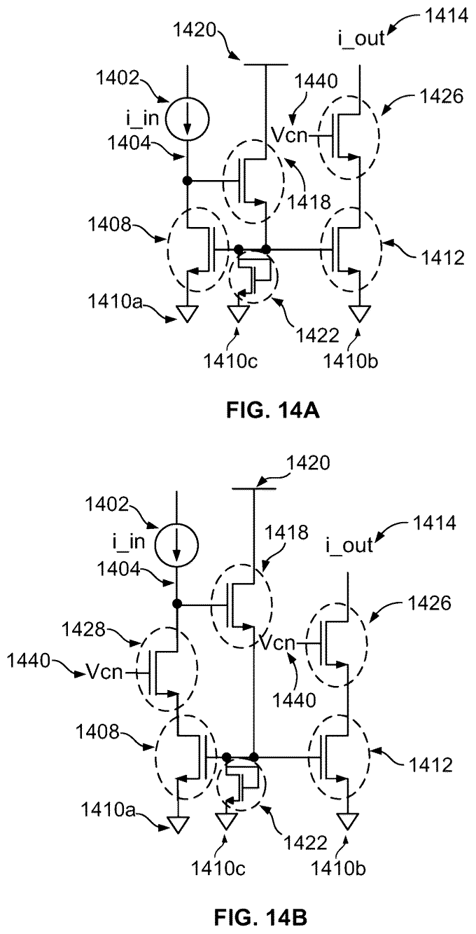

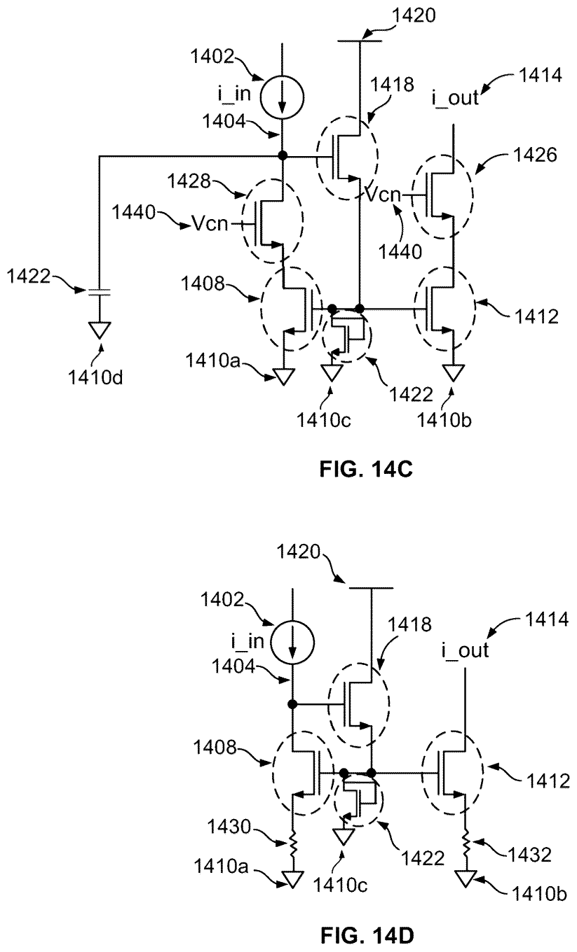

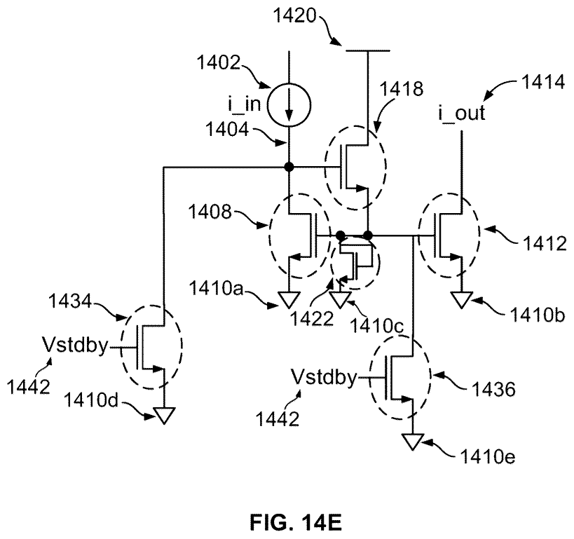

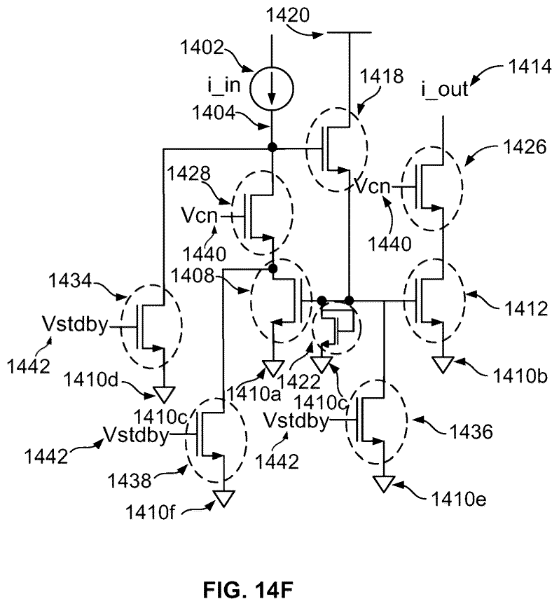

FIG. 14A depicts a schematic diagram of a MOSFET current mirror including a startup transistor, DC pull-down transistor, and a cascode at the output in accordance with an embodiment of the present disclosure. This current mirror is similar to and functions in a similar manner as that of the current mirror in FIG. 8B (e.g., input current 1402 corresponds to input current 852, electrical connections 1404 correspond to electrical connections 854, input transistor 1408 corresponds to input transistor 858, reference voltages 1410 correspond to reference voltages 860, output transistor 1412 corresponds to output transistor 862, output currents 1414 correspond to output current 864, startup transistor 1418 corresponds to startup transistor 868, power source 1420 corresponds to power source 870, and DC pull-down transistor 1422 corresponds to DC pull-down transistor 872). However, a cascode circuit is utilized where an additional output cascode 1426 is added in series with the output transistor 1412. By including this cascode it is possible to improve the performance of the current mirror, for example, by reaching a higher output impedance.

The numbered elements of FIG. 14A are similar to and function in a similar manner as the components of FIG. 8B. However, an output cascode 1426 is added in series with the output transistor 1412. Similar to the other transistors in the current mirror (e.g., input transistor 1408, output transistor 1412), in this embodiment the output cascode 1426 is represented by a MOSFET (e.g., P-channel, N-channel). The circuit may be modified to accommodate other types of transistors such as a BJT, FET, IGBT, HBT, TFT, FinFET, or UJT. Within this current mirror schematic, a control signal (V_{cn}) 1440 is received by the gate terminal of the output cascode 1426. The applied voltage from the control signal 1440 to the gate may come from any current or voltage source and have any number of characteristics. It is responsible for controlling whether or not the output cascode 1426 is activated or inactivated. The output current 1414 flows from the drain of the output cascode 1426 to its source that is connected to the drain terminal of the output transistor 1412. Some embodiments may consist of multiple transistors, a combination of MOSFET types, and/or a combination of transistor types. Other components (e.g., resistor, diode) may be connected to the different terminals of the output cascode 1426. Note that there may be multiple output cascodes 1426 present within a single current mirror circuit.

FIG. 14B depicts a schematic diagram of a MOSFET current mirror including a startup transistor, DC pull-down transistor, and cascodes at the input and output in accordance with an embodiment of the present disclosure. This current mirror is similar to and functions in a similar manner as that of the current mirror in FIG. 14A. However, an input cascode 1428 is added in series with the input transistor 1408. By including this cascode it is possible to improve the performance of the current mirror, for example, by reaching a higher output impedance.

The numbered elements of FIG. 14B are similar to and function in a similar manner as the components of FIG. 14A. However, an input cascode 1428 is added in series with the input transistor 1408. Similar to the other transistors in the current mirror (e.g., input transistor 1408, output cascode 1426), in this embodiment the input cascode 142 is represented by a MOSFET (e.g., P-channel, N-channel). The circuit may be modified to accommodate other types of transistors such as a BJT, FET, IGBT, HBT, TFT, FinFET, or UJT. Within this current mirror schematic, a control signal (V_{cn}) 1440 is received by the gate terminal of the output cascode 1426. The applied voltage from the control signal 1440 to the gate may come from any current or voltage source and have any number of characteristics. It is responsible for controlling whether or not the input cascode 1428 is activated or inactivated. The same control signal 1440 may be used for some or all other components (e.g., cascodes) within the current mirror or each component may receive their own unique control signal 1440. The input current 1402 flows from the drain of the input cascode 1428 to its source that is connected to the drain terminal of the input transistor 1408. Some embodiments may consist of multiple transistors, a combination of MOSFET types, and/or a combination of transistor types. Other components (e.g., resistor, diode) may be connected to the different terminals of the input cascode 1428. Note that there may be multiple input cascodes 1428 present within a single current mirror circuit.

FIG. 14C depicts a schematic diagram of a MOSFET current mirror including a startup transistor, DC pull-down transistor, cascodes at the input and output, and a capacitor in parallel with the input transistor in accordance with an embodiment of the present disclosure. This current mirror is similar to and functions in a similar manner as that of the current mirror in FIG. 14B. However, a capacitor 1422 is added in parallel with the input cascode 1428. The inclusion of the capacitor 1422 may allow for the output current 1414 from the output transistor 1412 and output cascode 1426 to not overshoot the desired output current 1414 levels.

The numbered elements of FIG. 14C are similar to and function in a similar manner as the components of FIG. 14B. However, a capacitor 1422 that is connected to ground 1410 and parallel to the input cascode 1428 is present within the circuit. The size, type, and capacity of the capacitor 1422 may vary between current mirrors. By including the capacitor 1422 at this location, the input current 1402 pathway is split between the startup transistor 1418, the input cascode 1428, and the capacitor 1422. The threshold voltage of the startup transistor 1418 will require more time to reach, which allows for a more controlled opening of the gate terminal of the startup transistor 1418. In turn, the more controlled gate opening enables a more steady rise in output current 1414 levels as the gate of the output transistor 1412 is also more slowly opened. At the cost of additional time, minimal overshoot of the output current 1414 beyond the desired levels may be achieved. Reducing overshoot of output currents 1414 may be critical for sensitive current mirrors whose components may not be robust enough to withstand the elevated output currents 1414, even if only for a brief period of time.

FIG. 14D depicts a schematic diagram of a MOSFET current mirror including a startup transistor, DC pull-down transistor, and resistor degeneration at both the input and output in accordance with an embodiment of the present disclosure. This current mirror is similar to and functions in a similar manner as that of the current mirror in FIG. 8B. However, a degeneration resistor 1430 is added between ground 1410a and the input transistor 1408, in addition to another degeneration resistor 1432 being added between ground 1410c and the output transistor 1412. By including the degeneration resistor 1430 at the input transistor 1408 and degeneration resistor 1432 at the output transistor, it is possible to improve the performance of the current mirror, for example, better matching, lower noise, or higher output impedance.

The numbered elements of FIG. 14D are similar to and function in a similar manner as the components of FIG. 8B. However, a degeneration resistor 1430 is added between ground 1410a and the input transistor 1408, in addition to another degeneration resistor 1432 being added between ground 1410c and the output transistor 1412. The size, type, tolerance, frequency response capabilities, voltage coefficient, maximum operating voltage, material, and any other characteristics of the degeneration resistor 1430 and the degeneration resistor 1432 may vary between current mirrors. By including the degeneration resistor 1430 at the input transistor 1408 and degeneration resistor 1432 at the output transistor 1408, it is possible to improve the performance of the current mirror,, for example, better matching, lower noise, or higher output impedance.

FIG. 14E depicts a schematic diagram of a MOSFET current mirror containing shutdown transistors, a startup transistor, a DC pull-down transistor in accordance with an embodiment of the present disclosure. This current mirror is similar to and functions in a similar manner as that of the current mirror in FIG. 8B. However, a shutdown transistor 1434 is added in parallel with the input transistor 1408 and a shutdown transistor 1436 is added in parallel with the DC pull-down transistor 1422. By including the shutdown transistors 1434 and 1436, it is possible to disable the current mirror in a controlled fashion and reduce leakage currents during shutdown.

The numbered elements of FIG. 14E are similar to and function in a similar manner as the components of FIG. 8B. However, a shutdown transistor 1434 is added in parallel with the input transistor 1408 and a shutdown transistor 1436 is added in parallel with the DC pull-down transistor 1422. Similar to the other transistors in the current mirror (e.g., input transistor 1408, output transistor 1412), in this embodiment the shutdown transistor 1434 and the shutdown transistor 1436 are represented by a MOSFET (e.g., P-channel, N-channel). The circuit may be modified to accommodate other types of transistors such as a BJT, FET, IGBT, HBT, TFT, FinFET, or UJT. Within this current mirror schematic, a control signal (V_{standby}) 1442 is received by the gate terminal of the shutdown transistor 1434 and the shutdown transistor 1436. The applied voltage from the control signal 1442 to the gate may come from any current or voltage source and have any number of characteristics. It is responsible for controlling whether or not the shutdown transistor 1434 or the shutdown transistor 1436 is activated or inactivated. The same control signal 1442 may be used for some or all other components (e.g., cascodes) within the current mirror or each component may receive their own unique control signal 1442. Input current 1402 flows from the drain of the shutdown transistor 1434 to its source that is connected to ground 1410d when the control signal 1442 is applied to the gate terminal of the shutdown transistor 1434. Current flows from the source of the activated startup transistor 1418 to the drain of the shutdown transistor 1436. When the control signal 1442 is applied to the gate terminal of the shutdown transistor 1436, current is able to flow to its source that is connected to ground 1410e. Some embodiments may consist of multiple transistors, a combination of MOSFET types, and/or a combination of transistor types. Other components (e.g., resistor, diode) may be connected to the different terminals of the shutdown transistor 1434 and the shutdown transistor 1436. Note that there may be multiple shutdown transistors present within a single current mirror circuit.

FIG. 14F depicts a schematic diagram of a MOSFET current mirror containing shutdown transistors, a startup transistor, a DC pull-down transistor, and cascodes at the input and output in accordance with an embodiment of the present disclosure. This current mirror is similar to and functions in a similar manner as that of the current mirror in FIG. 14B. However, a shutdown transistor 1438 is added in parallel with the input transistor 1408, a shutdown transistor 1436 is added in parallel with the DC pull-down transistor 1422, and a shutdown transistor 1434 is added in parallel with the input cascode 1428. By including the shutdown transistor 1434, it is possible to properly shutdown input cascode transistor 1428. The shutdown transistor 1436 assists in properly shutting down startup transistor 1418 and output transistor 1412. The shutdown transistor 1438 is able to properly shutdown input transistor 1408.

The numbered elements of FIG. 14F are similar to and function in a similar manner as the components of FIG. 14B. However, a shutdown transistor 1438 is added in parallel with the input transistor 1408, a shutdown transistor 1436 is added in parallel with the DC pull-down transistor 1422, and a shutdown transistor 1434 is added in parallel with the input cascode 1428. Similar to the other transistors in the current mirror (e.g., input transistor 1408, output transistor 1412), in this embodiment the shutdown transistor 1434, shutdown transistor 1436, and the shutdown transistor 1438 are represented by a MOSFET (e.g., P-channel, N-channel). The circuit may be modified to accommodate other types of transistors such as a BJT, FET, IGBT, HBT, TFT, FinFET, or UJT. Within this current mirror schematic, a control signal (V_{standby}) 1442 is received by the gate terminal of the shutdown transistor 1434, shutdown transistor 1436, and shutdown transistor 1438. The applied voltage from the control signal 1442 to the gate may come from any current or voltage source and have any number of characteristics. It is responsible for controlling whether or not the transistor is activated or inactivated. The same control signal 1442 may be used for some or all other components (e.g., cascodes) within the current mirror or each component may receive their own unique control signal 1442. In some embodiments, the control signal 1440 for the cascodes may be the same as the control signal 1442 for the shutdown transistors. Input current 1402 flows from the drain of the shutdown transistor 1434 to its source that is connected to ground 1410d when the control signal 1442 is applied to the gate terminal of the shutdown transistor 1434. Current flows from the source of the activated startup transistor 1418 to the drain of the shutdown transistor 1436. When the control signal 1442 is applied to the gate terminal of the shutdown transistor 1436, current is able to flow to its source that is connected to ground 1410e. Current flows from the source of the activated input cascode 1428 to the drain of the shutdown transistor 1438. When the control signal 1442 is applied to the gate terminal of the shutdown transistor 1438, current is able to flow to its source that is connected to ground 1410f. Some embodiments may consist of multiple transistors, a combination of MOSFET types, and/or a combination of transistor types. Other components (e.g., resistor, diode) may be connected to the different terminals of the shutdown transistor 1434, the shutdown transistor 1436, and the shutdown transistor 1438. Note that there may be multiple shutdown transistors present within a single current mirror circuit.

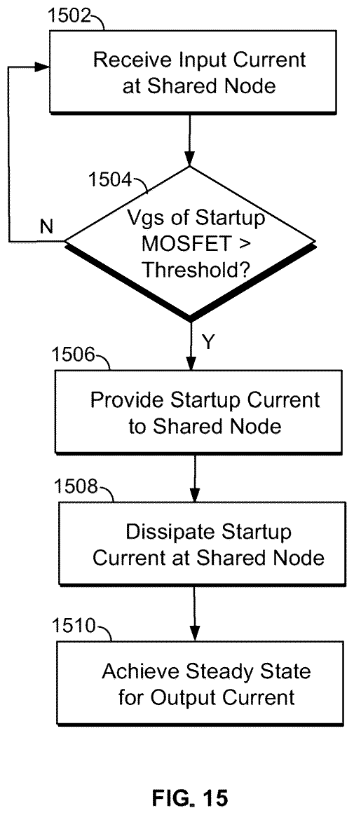

FIG. 15 depicts a flow diagram for a method of controlling the startup characteristics of a current mirror according to one aspect of an embodiment within the present disclosure. The steps include an input current being received at an input transistor, determining if that input current should be provided to the next component, and dissipating that input current to the rest of the circuit such that a fixed desirable output current at an output transistor may be attained. Although particular steps are depicted in a certain order for FIG. 15, steps may be removed, modified, or substituted. Further, additional steps (and the order of those steps) may be added in certain embodiments.

Processing starts at block 1502, where the input current flow is initiated. The input current may vary in magnitude and be AC, DC, or a composite waveform (e.g., AC with an overlapped DC). The source of the input current 202 may be a signal generated from a power source or any other current-producing component. The input current may come from anywhere within the current mirror circuit or adjacent circuits. Any number and type of component within the current mirror may receive the input current 202 (either directly or indirectly), such as capacitors, transistors, resistors, inductors, or diodes. The process may proceed to block 1504.

At block 1504 it is determined whether the gate to source voltage of the startup transistor (e.g., MOSFET) is greater than a threshold to electrically connect the startup MOSFET's drain to its source. If the input current supplied to the startup MOSFET is able to apply at least the threshold value to the gate terminal of the startup MOSFET, then the process may continue to block 156. If the input current is unable to apply at least the threshold value to the gate terminal of the startup MOSFET, the process returns to block 1502 and continues to loop through blocks 1504 and 1502.

At block 1506, the startup current is applied to the shared node via the startup MOSFET. Accordingly, the voltage at the shared node due to this current is applied the gate terminal of the output MOSFET(s). The process then continues to block 1508.

At block 1508, the startup current provided via the startup MOSFET causes a voltage to be provided at the shared node of the input MOSFET and output MOSFET(s) Once a threshold voltage for the output MOSFET(s) is met or exceeded, current can flow through the output MOSFET(s) to begin flow of the output current for each connected sub-circuit. In order to avoid overshooting of the output current, the startup current is initially dissipated, such as by a circuit element connected to the shared node (e.g., a finite non-zero DC impedance). Processing may then continue to block 1510, at which a steady state output current is achieved for each output MOSFET.

The foregoing description includes exemplary embodiments in accordance with the present disclosure. These examples are provided for purposes of illustration only, and not for purposes of limitation. It will be understood that the present disclosure may be implemented in forms different from those explicitly described and depicted herein and that various modifications, optimizations, and variations may be implemented by a person of ordinary skill in the present art, consistent with the following claims.

What is claimed is:

1. A current mirror, comprising:
an input transistor comprising an input node at a first node of the input transistor that receives a reference input current, a second node of the input transistor connected to a first reference voltage, and a third node of the input transistor connected at a shared node;
an output transistor comprising an output node at a first node of the output transistor, a second node of the output transistor connected to the first reference voltage, and a third node of the output transistor connected to the shared node;
a startup transistor comprising a first node of the startup transistor connected to a second reference voltage, a second node of the startup transistor connected to the shared node, and a third node of the startup transistor connected to the input node, wherein based on a startup signal at the third node of the startup transistor the startup transistor provides a path for a current to flow between the second reference voltage and the shared node; and
one or more components connected between the shared node and the first reference voltage, wherein the one or more components have a non-zero DC impedance, and wherein the one or more components create a DC current path between the shared node and the first reference voltage.

2. The current mirror of claim 1, wherein the current that flows between the second reference voltage and the shared node reduces a startup time for the output transistor to cause an output current to be received at the output node.

3. The current mirror of claim 1, wherein the startup transistor prevents current from passing from the first node of the startup transistor to the shared node while the startup signal is not received.

4. The current mirror of claim 3, wherein the startup signal comprises a signal having a voltage that crosses a threshold for the startup transistor.

5. The current mirror of claim 1, wherein the one or more components comprise a resistor or a diode-connected transistor.

6. The current mirror of claim 1, further comprising a capacitor located between the third node of the startup transistor and the first reference voltage.

7. The current mirror of claim 1, further comprising a first common-gate transistor connected in series with the first node of the output transistor, resulting in a cascode configuration for the output transistor.

8. The current mirror of claim 7, further comprising a second common-gate transistor connected in series with the first node of the input transistor, resulting in a cascode configuration for the input transistor.

9. The current mirror of claim 1, further comprising a plurality of additional output transistors, each of the plurality of additional output transistors comprising an additional respective output node at an additional respective first node of each additional respective output transistor, an additional respective second node of the additional respective output transistor connected to the first reference voltage, and an additional respective third node of the additional respective output transistor connected to the shared node.

10. The current mirror of claim 1, further comprising a first degeneration resistor located between the second node of the input transistor and the first reference voltage and a second degeneration resistor located between the second node of the output transistor and the first reference voltage.

11. The current mirror of claim 1, further comprising a shut-down transistor located between the shared node and the first reference voltage, wherein connecting the shared node to the first reference voltage via the shut-down transistor turns off the current mirror.

12. The current mirror of claim 1, wherein the input transistor and the output transistor are both metal-oxide-semiconductor field-effect transistors (MOSFET), and wherein the first node of the input transistor comprises a drain of the input transistor, the second node of the input transistor comprises a source of the input transistor, a third node of the input transistor comprises a gate of the input transistor, the first node of the output transistor comprises a drain of the output transistor, the second node of the output transistor comprises a source of the output transistor, and a third node of the output transistor comprises a gate of the output transistor.

13. The current mirror of claim 12, wherein the input transistor and the output transistor are both NMOS type MOSFETs, and the startup transistor comprises an NMOS MOSFET, a NPN transistor, or an N-JFET transistor.

14. The current mirror of claim 12, wherein the input transistor and the output transistor are both PMOS type MOSFETs, and the startup transistor comprises a PMOS MOSFET, a PNP transistor, or a P-JFET transistor.

15. The current mirror of claim 1, wherein the DC current path prevents the output transistor from overshooting a current supplied at the output node.

16. A method of controlling startup characteristics of a current mirror, comprising:
receiving an input current at a first node of an input transistor;
blocking, by a startup transistor based on a first voltage at the first node relative to a threshold, a startup current from being provided to a common gate node of the current mirror between a shared node of the input transistor and an output transistor;
providing, based on a second voltage at the first node relative to a second threshold, the startup current to the shared node; and
dissipating the startup current at the shared node when the startup current is initially provided to the shared node, wherein after the dissipating a voltage at the shared node reaches a steady state value that allows a fixed current to be provided at an output node of the output transistor.

17. The method of claim 16, wherein the blocking comprises a startup transistor preventing the startup current from flowing to the shared node based on the first voltage being applied at a gate of the startup transistor.

18. The method of claim 17, wherein the providing comprises the startup transistor allowing the startup current to flow to the shared node based on the second voltage being applied at the gate of the startup transistor.

19. The method of claim 16, wherein the providing the startup current reduces a startup time for the fixed current to be provided at the output node.

20. A current mirror having a decreased startup time, comprising:
an input voltage-controlled transistor having an input terminal coupled to receive at least a first portion of a reference current from a reference current source;
an output voltage-controlled transistor coupled to conduct an output current of the current mirror, the input voltage-controlled transistor and the output voltage-controlled transistor having respective control terminals coupled to each other at a common control node;
a start-up voltage-controlled transistor having a switchable conductive path coupled between a reference voltage and the common control node and operable in response to the reference current source to charge a parasitic capacitance between the common control node and a reference node when the switchable conductive path is in a conductive state; and
a non-zero finite impedance coupled between the common control node and the reference node.
